(19) United States
(12) Patent Application Publication
(10) Pub. No.: US 2008/0110538 A1
(43) Pub. Date: May 15, 2008

(54) GENERIC INFLATABLE PROTECTIVE COVER AND METHODS FOR MANUFACTURING SAME

(76) Inventors: Ioannis Varonos, Columbia, MO (US); Athanasios Kardon, Columbia, MO (US)

Correspondence Address: Andrew Jones, Suite 1080, 8144 Walnut Hill Lane, Dallas, TX, 75231, US

(21) Appl. No.: 11/937,554

(22) Filed: Nov. 9, 2007

Related U.S. Application Data
(60) Provisional application No. 60/865,040, filed on Nov. 9, 2006.

(51) Int. Cl. B60J 11/00

(52) U.S. Cl. 150/166; 296/136.1

(57) ABSTRACT

Disclosed herein are a protective cover and related system for protecting a vehicle from the elements, as well as methods of manufacturing the same. In one embodiment, a protective cover is provided that comprises an inflatable flexible air chamber having a rectilinear shape and sized to entirely cover an upper surface and sides of a vehicle, the air chamber having a length and a width each at least 10 times its thickness. In addition, the protective cover may comprise a valve connected to the air chamber for inflating the air chamber, and a hem surrounding the perimeter of the air chamber and laterally extending therefrom. In such an embodiment, the protective cover may also comprise fastening mechanisms disposed in the hem for securing the air chamber to the upper surface and sides of the vehicle.

### PRIORITY CLAIM AND RELATED APPLICATION

This application claims priority to U.S. Provisional Patent Application Ser. No. 60/865,040, filed Nov. 9, 2006, and entitled “Bouncecover.” This provisional application is hereby incorporated by reference in its entirety for all purposes.

### TECHNICAL FIELD

Disclosed embodiments herein relate generally to protective covers, and more particularly to a generic, inexpensive inflatable protective cover for use in protecting vehicles and other objects for the elements, and in particular, hail.

### BACKGROUND

The effects of a hail storm can cause widespread damage to an automobile or even other vehicles or objects susceptible to such blunt falling objects. Hailstones can be as large as four inches in diameter, impacting vehicle surfaces at velocities of up to one hundred miles an hour or more. Hailstones cause damage to both the body panels and the glass of vehicles. Thus, a hail storm can cost car owners and car dealers tremendously expensive damage, as well as cost insurance companies millions of dollars. Where insurance companies are involved, the effects of such damage are felt across the nation in higher insurance premiums and higher prices for automobiles. These effects are also felt by private citizens who do not have comprehensive insurance and must pay out of their own pockets to repair the thousands of dollars worth of damage a single hail storm can do to an automobile. In addition to the cost involved, the vehicle owner has to contend with the inconvenience of having to arrange for the repair and obtain temporary alternate transportation. In short, millions of dollars are wasted annually by insurance companies, dealerships and private citizens in the repetitive exercise of repairing automobiles and other vehicles that have sustained hail damage.

Traditionally, the only certain protection against such damage was to park the vehicle under a solid-roof structure which, in many instances, is not available. Conventional, non-inflatable vehicle covers are available for protecting vehicles from exposure to the weather, particularly sun and precipitation. These ordinary vehicle covers, however, provide little or no protection against falling objects. In addition, certain padded or inflatable covers have been developed that attempt to protect a vehicle from small falling objects such as hailstones. However, conventionally available covers are typically complex in design and structure, and thus are expensive to manufacture. For example, most are constructed with a large number of tubular cell that are filled with air to form a cushion that is intended to prevent falling objects from damaging the vehicle surface. Not only are such designs more expensive and complex to manufacture because of interconnection of such multiple tubular chambers, the resiliency of such covers may be questionable at the point where cells are adjoined.

Other available covers are expensive to manufacture because of the materials involved, and in many cases are heavy and difficult for a single person to use easily. Still others are pre-formed to generally match the shape of the vehicle it is protecting, which can be a complex and expensive manufacturing process. In all such cases, the increased manufacturing cost, whether because of complexity or materials, is passed on to the consumer in the form of higher prices. In addition, covers customized for certain vehicles or objects, while perhaps successful in protecting against objects such as hailstones, are typically limited in use to only the vehicle or object for which it is designed.

Accordingly, what is needed in the art is a protective cover, and related process for manufacturing such a cover, that is generic in shape for use with a variety of vehicles and objects, is manufactured from relatively inexpensive materials, and has a design and structure that is simple and inexpensive to manufacture. The present disclosure provides such a solution.

### SUMMARY

Disclosed herein are a protective cover and related system for protecting a vehicle from the elements, as well as methods of manufacturing the same. The protective cover is manufactured into a vessel or chamber to contain air in order to prevent impact of material hitting the upper layer of the protective cover from reaching the surface of the object protected by the lower layer of the protective cover. The protective cover may be used for the protection of automobiles against, for example, hail, as well as the impact of any medium sized blunt objects of medium velocity on any object to be protected. In addition, the protective cover may be manufactured into different shapes than for use with automobiles, for example, for protecting camping tents, boat protection, a cover for antennas and satellite dishes when not in use, and for protection of any other object desired.

In one aspect, a protective cover is disclosed. In one embodiment, the protective cover comprises an inflatable flexible air chamber having a rectilinear shape and sized to entirely cover an upper surface and sides of a vehicle, the air chamber having a length and a width each at least 10 times its thickness. In addition, the protective cover may comprise a valve connected to the air chamber for inflating the air chamber, and a hem surrounding the perimeter of the air chamber and laterally extending therefrom. In such an embodiment, the protective cover may also comprise fastening mechanisms disposed in the hem for securing the air chamber to the upper surface and sides of the vehicle.

In another aspect, a system for protecting a vehicle is also disclosed. In one embodiment, the system comprises a protective cover, which itself may comprise an inflatable air chamber having a rectilinear shape and sized to entirely cover an upper surface and sides of a vehicle. In addition, the protective cover may also comprise a valve connected to the air chamber for inflating the air chamber, a hem surrounding the perimeter of the air chamber and laterally extending therefrom, and retaining rings disposed in the hem along the length of the protective cover. In such an embodiment, the system may further comprise elastic bands disposed along widths of the hem and the front and rear of the protective cover, the elastic bands adapted to engage around front and rear portions of the vehicle. Still further, such a system may include straps configured to attached to the retaining rings and pass under the vehicle, the straps securing the air chamber to an upper surface of the vehicle. Finally, in such an embodiment, the system may include an inflating device adapted to inflate the air chamber via the valve.

In yet another aspect, a method of manufacturing a protective cover for a vehicle is disclosed. In one embodiment, the method comprises forming an inflatable air chamber having a rectilinear shape by providing 4 pieces of material to comprise the four sides of the air chamber, providing 2 pieces of material to comprise the top and bottom of the air chamber, wherein the bottom piece is sized larger than the top piece so as to provide a hem surrounding the perimeter of the air chamber that laterally extends therefrom, and then connecting the 6 pieces to one another so as to form the air chamber having the hem. In addition, an air valve may be provided through one of the 6 pieces for inflating the air chamber. Such a method of manufacturing may also include forming fastening mechanisms in the hem for securing the air chamber to the upper surface and sides of a vehicle.

### BRIEF DESCRIPTION OF THE DRAWINGS

For a more complete understanding of this disclosure, and the advantages of the systems and methods herein, reference is now made to the following descriptions taken in conjunction with the accompanying drawings, in which:

FIG. 1 illustrates one embodiment of a protective cover constructed in accordance with the disclosed principles;

FIG. 2 illustrates a side view of the protective cover shown in FIG. 1;

FIG. 3 illustrates a front view of the protective cover illustrated in FIGS. 1 and 2

FIG. 4 illustrates cross-section side and front view of a protective cover constructed in accordance with the disclosed principles secured to an automobile; and

FIG. 5 illustrates an exploded isometric view of the protective cover illustrated in the prior figures, which is constructed in accordance with the principles disclosed herein.

### DETAILED DESCRIPTION

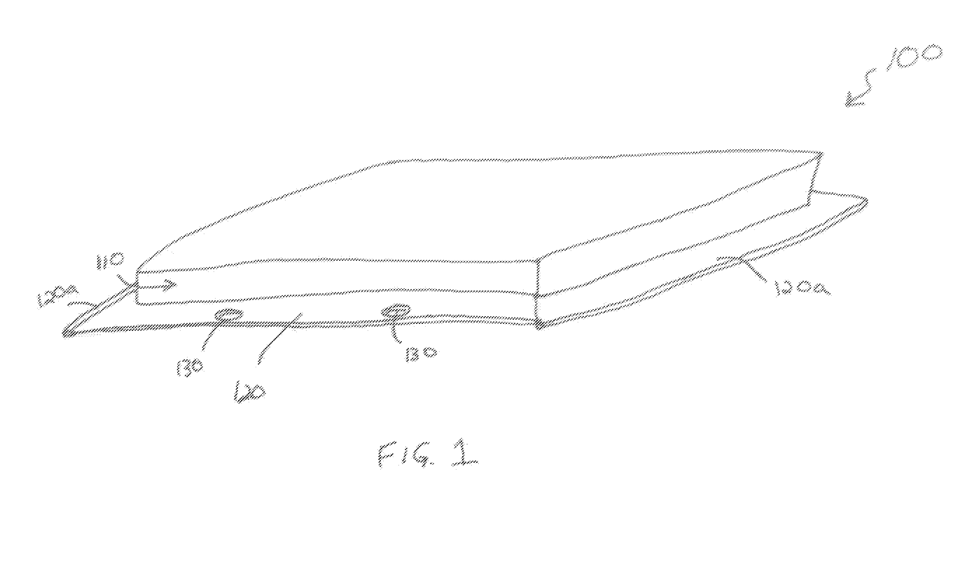

Referring initially to FIG. 1, illustrated is one embodiment of a protective cover 100 constructed in accordance with the disclosed principles. Reference is made throughout this disclosure to a protective cover 100 for use in protecting a vehicle. However, it should be understood that such generalization is for simplification of the description herein, and thus a protective cover 100 constructed according to the disclosed principles may be used to protect any type of vehicle or other object, without limitation.

The protective cover 100 illustrated includes a single inflatable air chamber 110 having a generic rectilinear shape. In other embodiments, the protective cover 100 may be constructed with more than one inflatable chamber 110, if desired. In embodiments, where multiple air chambers 110 are constructed, the discussion below with the regard to the inflation of the air chamber 110 should be adjusted to accommodate the inflation of the multiple chambers. By providing the protective cover 100 as a generally rectilinear shape, a protective cover 100 according to the disclosed principles is advantageously useable with virtually any shape or type of vehicle or other equipment being protected. In addition, by having only a generic rectilinear shape, the expense and time-consuming process of customizing the protective cover 100 for particular size and/or shapes of vehicles or other items is eliminated. Of course, be greatly reducing the cost of designing and manufacturing a protective cover 100 according to the disclosed principles, the cost savings may be passed on the consumers, thereby reducing the overall purchase price for a protective cover 100 constructed according to the disclosed principles. Moreover, instead of having to buy multiple protective cover 100s for different vehicles or other equipment one might want to protect, a single protective cover 100 as disclosed herein may possibly provide the protection for a large number of various sized and shaped items in need of protection.

Generally speaking, the material selected for constructing the inflatable chamber 110 should be air tight and waterproof and otherwise capable of withstanding the elements since the protective cover 100 will typically be employed as the sole means of protection for the vehicle or other item from the weather. In some embodiments, the protective cover 100 may be constructed from Silk-iene®, a very fine and extremely lightweight flexible 30 denier nylon rip-stop fabric that is double coated with silicone (one coat of silicone on each side of the material). Saturation coating with silicone on each side of the material gives the fabric the desired zero porosity attribute. Accordingly, no air passes through the material. In other embodiments, the sealant used to air- and waterproof the protective cover 100 may be Silnet®. Silnet is a sealant specially formulated for providing the sealing properties found on, for example, tents and other outdoor products. Silnet is typically silicone-based, and is often used to treat nylon material. In order to construct the protective cover 100, any weather resistant thread may be employed. For example, any 100% nylon thread is sufficient, however, other thread materials may also be employed.

Any type of air valve currently available, or even later developed, may be used for inflating the inflatable chamber 110 of the protective cover 100. Turning to FIG. 2, with continued reference to FIG. 1, illustrated is a side view of the protective cover 100 shown in FIG. 1. In addition, the components of the protective cover 100 discussed above, FIG. 2 also illustrates an air valve 150 that was not visible from the view in FIG. 1. In some embodiments, air valves 150 used for automobile tires are sufficient for use with the protective cover 100. In addition, depending on the type of air valve 150 employed, the valve 150 may be secured to the material or other fabric comprising the inflatable chamber 110. In a simplified embodiment, a typical rubber tire patch 160 may be employed since such patches are designed to bond rubber materials. As such, the tire patch 160 may be used to bond (e.g., rubber weld) a valve 150 having a rubber exterior to the inflatable chamber 110. Of course, other approaches to install an air valve 150 to the inflatable chamber 110 may also be employed, and no limitation to this exemplary approach is intended.

To inflate a protective cover 100 constructed as disclosed herein, any type of air pump (not illustrated) may be used with a protective cover 100 constructed as disclosed herein. In some embodiments, a portable battery or plug-in air pump may be employed. In other embodiments, a fixed air pump may be used to inflate the protective cover 100. Also, the air pump used may be automatically or manually operated. Still further, in some embodiments, a traditional pump may not be used, and instead a tank of compressed air may employed to inflate the protective cover 100. Such a tank may be a portable tank, such a type that could be carried in the vehicle being protected, or may be part of an air compressor system, such as the type found in automotive shops or even in home garages. In short, the inflation of the protective cover 100 may be by any means, either now existing or later developed.

Advantageously, once a protective cover 100 constructed as disclosed herein is inflated to the proper pressure, the inflation mechanism may be disengaged. Specifically, in many conventional inflatable covers, a constant inflation pressure must be maintained by the inflation equipment. Of course, such covers therefore cost more to operate, and also require some type of pressure regulation device to maintain the pressure over the period the cover is to be used. By eliminating such approaches, a protective cover 100 constructed as disclosed herein simplifies the manufacture and operation of the protective cover 100, thereby again advantageously reducing overall costs to the consumer.

Constructed around the bottom perimeter of the inflatable air chamber 110 is a hem 120 of the protective cover 100. Typically, the hem 120 is not an inflatable portion of the protective cover 100, and is instead stitched or otherwise attached to the bottom perimeter of the air chamber 110. As before, nylon or other such thread may be used to attached the hem, or, alternatively, the hem may simply be the extension of material from a surface of the air chamber 110 that extends past where the air chamber 110 has been sealed in order to be inflatable.

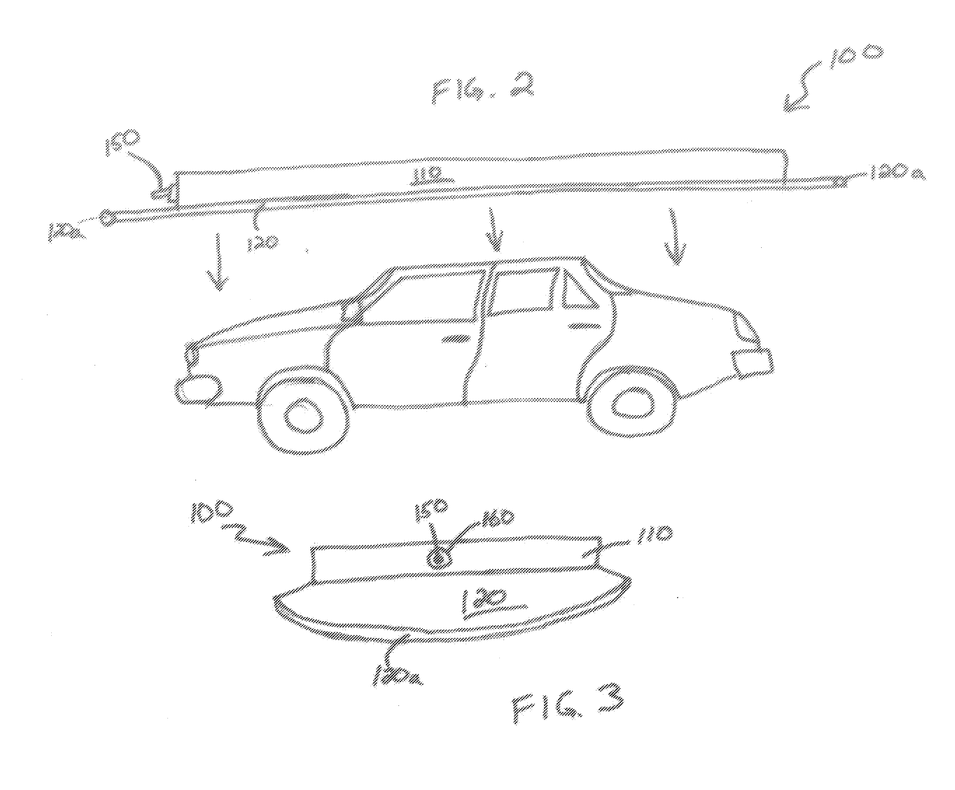

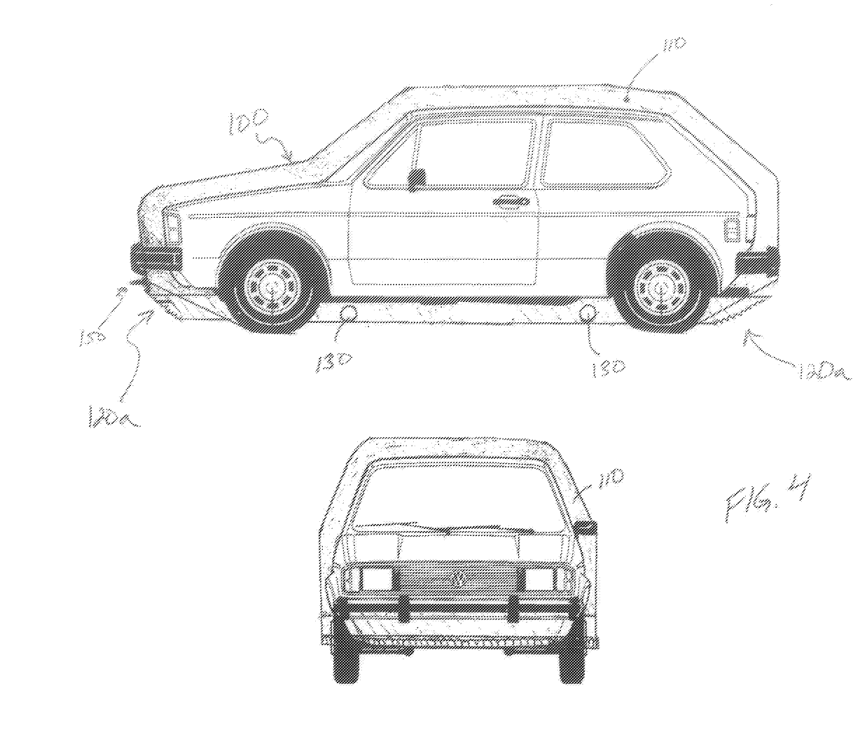

To assist in securing the protective cover 100 to a vehicle or other item, the ends of the protective cover 100 may also be constructed with an elasticized portion 120a on the hem 120. FIG. 3 illustrates a front view of the protective cover 100 illustrated in FIGS. 1 and 2. More specifically, the ends of the hem 120 around the protective cover 100 include elasticized portions 120a so that as the protective cover 100 is fit over a vehicle, the elasticized portions 120a of the hem 120 can be stretched over the front and rear ends of the vehicle being protected to help attach the protective cover 100 to that vehicles. In other embodiments, the entire perimeter of the hem 120 is elasticized to further assist in securing the protective cover 100 to the vehicle being protected.

Once stretched over the ends of the vehicle, additional means may be used to further secure the protective cover 100 to the vehicle along the sides of the protective cover 100. Specifically, retaining rings 130 may be secured to the material of the protective cover 100. More specifically, as discussed in detail above, the protective cover 100 typically would include a hem around its lowest perimeter, where the hem is not inflated as part of the chamber(s) 110 comprising the protective portion of the protective cover 100. In specific embodiments, four retaining rings 130 may be used in the process of securing the protective cover 100 in place. The retaining rings 130 may be stitched to the hem, and placed in appropriate locations to secure the protective cover 100 to the vehicle, such as proximate to the quarter-panels when an automobile is being protected. Of course, any number of retaining rings 130 may be employed, as needed, and it is envisioned that more than four retaining rings 130 may be needed if the protective cover 100 is manufactured to cover a large vehicle or object, whereas only four, or perhaps less, retaining rings 130 would be required for smaller-sized protective cover 100s.

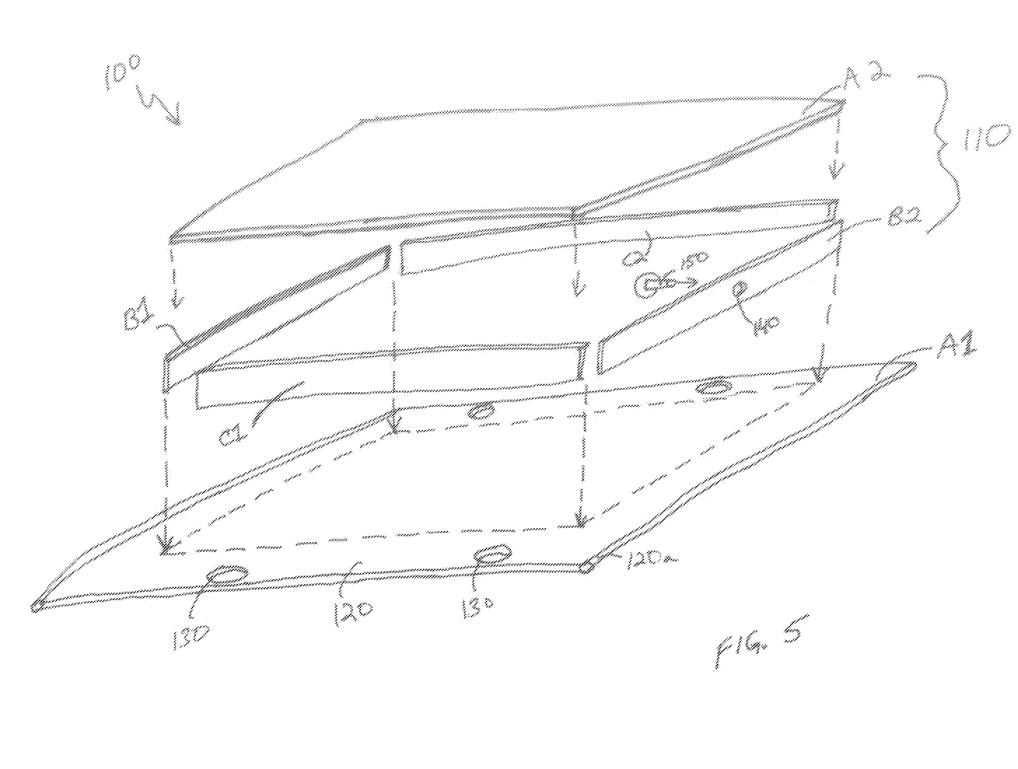

During use of the protective cover 100, a rope, strap or even bungee cord could be used to fasten one retaining ring 130 to one or more of the other rings 130. FIG. 4 illustrates a protective cover constructed in accordance with the disclosed principles applied to an automobile to protect the vehicle from the environment. In some embodiments, as illustrated, lashing straps may be employed, such as those straps having adjustable buckles or even a ratcheting mechanism to tighten the strap. Of course, any type of strap may be employed to secure the protective cover 100 to the vehicle. Moreover, such fastening typically would occur under the vehicle, as shown in FIG. 4. In advantageous embodiments, the retaining rings 130 are constructed of stainless steel. In other embodiments, the rings 130 may be constructed of coated steel, for example, zinc coating, in order to protect the rings 130 from the elements.

Although the protective cover 100, an in particular the air chamber(s) 110, is manufactured in the advantageous generic rectilinear shape discussed in detail above, the flexible nature of the material used to construct the air chamber 110 allows the protective cover 100 to somewhat flex with the contour and shape of the item (e.g., a vehicle in FIG. 4) it is mounted on. More specifically, as the protective cover 100 is tightened onto the top of the vehicle, for example, with the ratcheting straps discussed above, the air chamber 110 is continuously pulled down onto the top surfaces of the vehicle. As the protective cover 100 is tightened further and further onto the vehicle, the air chamber 110 flexes to accommodate the shape and contour of the upper surfaces of the vehicle. Accordingly, rather than having to customize the protective cover 100 itself to the shape and contour of the item it is intended to protect, the generic rectilinear shape of the protective cover 100 allows it to fit variously shaped items, while the flexible nature of the material used to manufacture the air chamber 110 allows the protective cover 100 to accommodate the shape of the item as it is fastened onto the item.

What follows now is an exemplary embodiment of a process for the construction of the medium-sized protective cover 100 discussed above, in accordance with the disclosed principles. However, it should be noted that the same or similar principles discussed below may be employed to manufacture a protective cover 100 of any larger or smaller size, without departing from the spirit and scope of the disclosed principles. In the market today, the manufactures of car and other vehicle covers produce covers with dimensions from about 13′2″ to 22′, and typically categorized into five different sizes based on car length (13′2″-14′2″, 14′3″-16′8″, 16;9″-19′, and 19′1″ to 22). To simplify the discussion below, certain dimensions for the vehicle and protective cover 100 are assumed, without excluding the construction of the protective cover 100 to potentially fit all sizes and shapes. As such, the dimensions for the exemplary protective cover 100 discussed below are: length—16′, width—13′, and a height—X (of the inflated part). Of course, any size protective cover 100 may be constructed, and no limitation to any particular dimensions is intended or should be implied.

FIG. 5 illustrated an exploded isometric view of the protective cover 100 illustrated in the prior figures, which is constructed in accordance with the principles disclosed herein. The construction process may begin with the cutting of the Silk-iene fabric into the various pieces that will be stitched or otherwise connected together to create the protective cover 100. The process begins in this exemplary embodiment by cutting a piece of material having approximate dimensions of 16′×13′ to produce piece A1, which represents the maximum perimeter of the protective cover 100 including the hem 120. A second piece having dimensions 15′×12′, and which represents piece A2, may then be cut. This piece A2 represents the top of the inflatable air chamber 110. Next, the ends of the air chamber 110 are cut from the same material. Specifically, two pieces B1, B2 having dimensions of approximately 12′×6″ are cut. In addition, two more pieces C1, C2 are cut that represent the sides of the air chamber 110. These pieces C1, C2 are cut to approximately dimensions of 15′×6″.

Now a standard tire air valve 150 may be placed through the center of standard a tire repair patch 160 until there is a snug fit at the upper end of the base of the valve 150. By using standard PVC glue, the patch 160 may be secured to the valve 150. Of course, any commercially available adhesive may be used to hold these pieces together. In the center of end piece B2, a small hole 140 approximately the diameter of the outside of the tire valve 150 is made. The valve 150 is placed through the hole 140 so that the patch 160 rests against the surface of piece B2 around the hole 140. Adhesive or sealant, for example, Silnet, may be applied generously on both sides of the piece B2 around the valve 150 and between the patch 160 and the material B2. If Silnet is used, it typically is left to solidify and cure to achieve its full strength for 16 hours.

As mentioned above, piece A1 is the piece that lays directly on the surface of the vehicle or other item to be protected. Since in this embodiment, the air chamber 110 is defined to be 15′×12′×6″, all of the seams may be located about 6″ interior to the edges of piece A1. Specifically, on the dimension of length of piece A1, which is 16′, at approximately 6″ off each edge the first seam with piece C1 occurs. Again measuring 6″ off another edge of A1 the seam between piece B2 and A1 is made, as well as between piece B2 and piece C1 at right angle with respect to C1. The height of pieces B1, B2, C1 and C2 all represent the thickness of the inflatable chamber 110. The next step in the process is to again measure 6″ of the side of A1 facing piece B1, and make the seam between piece B1 and piece A1, and between piece C2 at a right angle with piece B1. Similarly, again 6″ is measured off of the side of A1 this time facing piece C1, and the seam between piece C1 and piece A1 is made, and also between piece C1 at a right angle with piece B1.

The final piece may now be connected to the rest of the protective cover 100. Specifically, piece A2 is placed parallel to A1 and at right angles to B1, C1, B2 and C2. This may be done in two stages. First, piece A2 may be connected with seams in the orientation described with C2, B2, C1. The seams will be lined on the exterior and interior surfaces with a sealant, again such as Silnet, and curing time may be given so that it reaches its full strength. Second, is the connection between piece A2 and piece B1. For the obvious reason, one cannot first place these pieces in place together, and then line the interior part of the seam with adhesive. Therefore, an approximation of where pieces A2 and B1 will connect is done. Specifically, at about 1.25 inches from the approximation of this intended seam. From that point of approximation, for the length of B1 and with a width of 1″, that area may be lined with adhesive and the two piece placed together. After the Silnet or other adhesive/sealant cures and reaches its full effect, the remaining 0.25″ of the two approximate surfaces would be used for the application of the seam, and afterwards the exterior of the seam could further be lined with Silnet again.

In all of the seams described above, the nature of how the seam is made is determined by the manufacturer of the protective cover 100 at the time; however, double stitching of the seams is recommended in the experience of the present inventors. Additionally, along the construction process, Silnet or other advantageous sealant or adhesive may be applied to all of the seams between all of the various pieces of the protective cover 100 to ensure an air tight seal in all areas. As before, if Silnet is used here, ample cure time for the sealant may be provided before continuing with the construction process.

In the preceding steps of the construction of the protective cover 100, it is established that both the length and the width of piece A1 extends 6″ from the inflatable air chamber 110 portion of the protective cover 100. That 6″ of fabric now surround the air chamber 110 as the hem 120. At the final 1″ of that hem 120, the material may be folded 1″ for the perimeter of the protective cover 100, and then stitching that fold back on to piece A1. In this manner, a space 120a at the hem 120 is created for an elastic band to be inserted in order to elasticize the hem as described above.

Then, in this embodiment, two retaining rings 130 are stitched on each side of the length of the hem 120 of piece A1. Each pair of retaining rings 130 may be placed 3′ off the end of the length side of piece A1 parallel to each other, approximating a position behind the front wheels and in front of the rear wheels of the vehicle being protected. This positioning may be seen in FIG. 4. The internal diameter of the retaining rings 130 is recommended to be 1⅝″, however, other sizes could also be used. As described in detail above, the use of the retaining rings 130 in the protective cover 100 will allow the use of two fastening straps, for example, light duty lashing straps 14 feet long and 1 inch wide, with a stainless steel buckle to adjust length. Once attached to the vehicle or other item, an inflation device as discussed in detail above may then be used to inflate the air chamber 110. By inflating the air chamber 110 after securely attaching the protective cover 100 to the vehicle, the cover 100 will easily follow the curvature and shape of the vehicle. Of course, pre-inflation and then cinching the protective cover 100 down on the vehicle also allows the disclosed cover 100 to conform to the shape of the vehicle.

### Hail Impact Analysis

In this section, an analysis is presented of all variables that directly contribute and effect the design section of the protective cover 100 with regard to hail impact. The first portion of this section will deal with hail data. Following the first part, a demonstration of the scientific data regarding the inflatable air chamber 110 of the protective cover 100 is provided. Finally, from both parts there will be a conclusion for the proposed design with regard to hail protection and impact.

### Hail Data

The first concern in this analysis is the calculation of hail mass. There is a large amount of data available from the National Weather Service regarding the variations in hail mass. In the present calculations, the worst case scenario is assumed, and thus the following are given:
1) Hail has spherical mass
2) No air bubbles in hail mass
3) Largest ever recorded solid ice hail density (p=917 kg/³) (weather.ou.edu/˜metr3223/physec9.pdf. Graupel and hail growth)
4) Largest ever recorded diameter (D=4.5 inches 11.4 cm=0.114 m) (“softball size”) (http://www.spc.noaa.gov/misc/tables/hailsize.htm)

### The volume will be calculated based on the following equation (1):

V=(4/3)π(D/2)³ (1)

where D=0.114 m. Therefore the volume is V=7.757366×10⁻⁴ m^{3.} The mass is calculated using equation (2):

m=p×V (2)

Therefore, using these equations, mass is calculated as m=0.7113 kg. Historical data on hail indicates that 0.75 kg is the largest mass recorded ever, so this calculated mass is suitable for a worst case scenario example. (http://www.newton.dep.anl.gov/askasci/gen99/gen99107.htm)

Assuming in this model that the hail is in a state of free fall (i.e., g=9.81 m/sec²) until impact with the protective cover 100, we eliminate the air resistance and wind velocity because that allows calculation of a worst case deflection cushion for the protective cover 100. To aid in this goal, it is also assumed that all impact occurs at right angles with the inflatable air chamber 110 since that way maximum impact occurs (impact at an angle is weaker). The ground temperature during hail impact has been known to fluctuate. In the present case, the chosen temperature is 79° F. (26° C.) which was the highest temperature for Mar. 30, 2006 in Columbia, Mo., where a hail storm occurred that was documented by the National Weather Service. (www.wunderground.com/history/airport/KCOU/2006/3/30/DailyHistory); (www.spc.nssl.noaa.gov/exper/archive/events/060330/index.html)

### Next, the force of impact on the exemplary protective cover 100 is calculated using equation (3):

F=mg (3)

### Thus, with m=0.7113 Kg, and we know g=9.81 m/sec². Therefore, plugging to equation (3) the products from equations (1) and (2):

F=(0.7113 Kg) (9.81 m/sec²)=6.9779 N.

### Protective Cover Data

The volume (V) of the air chamber 110 of the protective cover 100 in the present example is calculated using equation (4):

V=length×width×height (4)

Thus, using the dimensions of the air chamber 110 discussed above:

V=(4.572 m)×(3.6576 m)×(0.1524 m)=2.5485 m³

### The pressure of the air chamber 110 of the protective cover 100 is calculated using equation (5):

PV=nRT (5)

where “n” is the number of moles in air (3.23×10²⁰ moles), R is the universal gas constant (0.082×10⁻³ (m³ atm/mol K)), and T is the selected temperature (79° F.=299.26 K). Therefore.

P=3.11014×10¹⁸ (atm).

### Force on the Protective Cover

Finally, the force (F) acted upon the protective cover 100 throughout the surface of the air chamber 110 is calculated using equation (6):

F=P×A (6)

where P is the pressure in the air chamber 110 and A is the area of the air chamber. Using the measurements discussed above for constructing the air chamber 110,

A=(2×4.572 m×3.6576 m)+(2×3.6576 m×0.1524 m)+(2×4.572 m×0.1524 m)=35.953 m².

Plugging this information into equation (6) results in:

F=PA=3.11014×10¹⁸×101325 (N/m²)×35.953 m²=1.133×m²⁵ N.

Using the above information, the present inventors have found that the force exerted on the surface of the exemplary protective cover 100 from the air contained in the inflatable air chamber 110 is several orders of magnitude larger then the force exerted at impact from the above hail model, which was 6.9778 N. Therefore, according to the conditions set in the present example (right angle impact), hail impacting the air chamber 110 with the maximum calculated force will simply bounce off of the air chamber portion of the protective cover 100, thus leaving the vehicle or other item being protected undamaged from even the largest and most severe hail ever recorded. Moreover, this type of advantageous protection is provided by a protective cover having generic rectilinear shape that is adapted for use with almost any item in need of protection. Because of this generic construction, such a protective cover is therefore much less expensive to manufacture and thus much less expensive for consumers to purchase.

While various embodiments of a protective cover according to the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A protective cover, comprising:
an inflatable flexible air chamber having a rectilinear shape and sized to entirely cover an upper surface and sides of a vehicle, the air chamber having a length and a width each at least 10 times its thickness;
a valve connected to the air chamber for inflating the air chamber;
a hem surrounding the perimeter of the air chamber and laterally extending therefrom; and
fastening mechanisms disposed in the hem for securing the air chamber to the upper surface and sides of the vehicle.

2. A protective cover according to claim 1, wherein the air chamber has a length and a width each at least 10 times its thickness.

3. A protective cover according to claim 2, wherein the air chamber has a thickness of about 6 inches.

4. A protective cover according to claim 1, wherein the air chamber is constructed from a rubberized material such that the air chamber is air and water tight.

5. A protective cover according to claim 4, wherein the rubberized material comprises silicone.

6. A protective cover according to claim 1, wherein the air chamber is sized and inflated to have an area of about 35.953 m² and an internal air pressure of about 3.11014×10¹⁸ (atm).

7. A protective cover according to claim 1, wherein the fastening mechanisms comprise retaining rings for use with straps securing the air chamber to the vehicle.

8. A protective cover according to claim 1, wherein the fastening mechanisms comprise elastic bands disposed in front and rear portions of the hem and adapted to engage around front and rear portions of the vehicle.

9. A protective cover according to claim 1, wherein the fastening mechanisms comprise an elastic band disposed along the entire perimeter of the hem for engaging under-portions of the vehicle.

10. A system for protecting a vehicle, the system comprising:
a protective cover comprising:
an inflatable air chamber having a rectilinear shape and sized to entirely cover an upper surface and sides of a vehicle,
a valve connected to the air chamber for inflating the air chamber,
a hem surrounding the perimeter of the air chamber and laterally extending therefrom, and
retaining rings disposed in the hem along the length of the protective cover;
elastic bands disposed along widths of the hem and the front and rear of the protective cover, the elastic bands adapted to engage around front and rear portions of the vehicle;
straps configured to attached to the retaining rings and pass under the vehicle, the straps securing the air chamber to an upper surface of the vehicle; and
an inflating device adapted to inflate the air chamber via the valve.

11. A protective cover according to claim 10, wherein the air chamber has a length and a width each at least 10 times its thickness.

12. A system according to claim 11, wherein the air chamber has a thickness of about 6 inches.

13. A system according to claim 10, wherein the air chamber is constructed from a rubberized material such that the air chamber is air and water tight.

14. A system according to claim 13, wherein the rubberized material comprises silicone.

15. A system according to claim 10, wherein the air chamber is sized and inflated to have an area of about 35.953 m² and an internal air pressure of about 3.11014×10¹⁸ (atm).

16. A method of manufacturing a protective cover for a vehicle, the method comprising:
forming an inflatable air chamber having a rectilinear shape by:
providing 4 pieces of material to comprise the four sides of the air chamber, wherein lengths of the 4 side pieces are at least 10 times greater than their widths,
providing 2 pieces of material to comprise the top and bottom of the air chamber, wherein the bottom piece is sized larger than the top piece so as to provide a hem surrounding the perimeter of the air chamber that laterally extends therefrom,
connecting the 6 pieces to one another so as to form the air chamber having the hem, and
providing an air valve through one of the 6 pieces for inflating the air chamber;
forming fastening mechanisms in the hem for securing the air chamber to the upper surface and sides of a vehicle.

17. A method according to claim 16, wherein forming fastening mechanisms comprises placing retaining rings in the hem along the length of the protective cover.

18. A method according to claim 16, wherein forming fastening mechanisms comprises elastic bands disposed along at least portions of the hem, the elastic bands adapted to engage around corresponding portions of the vehicle.

19. A method according to claim 16, wherein connecting comprises stitching or rubber welding the pieces together.

20. A method according to claim 16, wherein the 6 pieces forming the air chamber comprise rubberized material such that the air chamber is air and water tight.
